(19) United States
(12) Patent Application Publication
(10) Pub. No.: US 2009/0224952 A1
(43) Pub. Date: Sep. 10, 2009

(54) OFFSET ADJUSTING CIRCUIT

(76) Inventor: Masami Funabashi, Osaka (JP)

Correspondence Address: MCDERMOTT WILL & EMERY LLP, 600 13TH STREET, NW, WASHINGTON, DC, 20005-3096, US

(21) Appl. No.: 12/092,475

(22) PCT Filed: Jul. 28, 2006
(86) PCT No.: PCT/JP2006/314983

§ 371 Date: May 2, 2008

(30) Foreign Application Priority Data
Nov. 14, 2005 (JP) 2005-329037

(51) Int. Cl. H03M 1/12

(52) U.S. Cl. 341/142

(57) ABSTRACT

An AD output average computation circuit 103 computes an average value of output values of 16 pixels from an AD converter 102. A subtractor 105 computes a difference value between the average value and a first AD output reference value. A clip circuit 106 selects analog offset correction or digital offset correction depending on the difference value. In the analog offset correction, a digital integrating circuit composed of a data hold circuit 108 and a subtractor 109 integrates the difference value to obtain an offset correction value, from which an offset correction voltage is generated by a DA converter 111 and an offset voltage generation circuit 112, to be used for correcting the offset of an amplifier 101. In the digital offset correction, a predetermined value is added to the output value of the AD converter 102 by an adder 113b to correct an offset amount.

### TECHNICAL FIELD

The present invention relates to an offset adjusting circuit for performing offset correction for an amplifier output and the like.

### BACKGROUND ART

In circuits handling an analog image signal in videos and cameras, for example, an analog front-end circuit for processing the output of an image sensor is sometimes provided with an offset adjusting circuit for black level adjustment and amplifier offset adjustment.

As such an offset adjusting circuit, a circuit is known in which the difference between an AD-converted amplifier output and a predetermined reference value is integrated by an analog integrating circuit to generate a desired clamp voltage (used as a control signal for adjusting the offset of the amplifier), to thereby perform output offset adjustment (clamp adjustment) of the amplifier (see Patent Document 1, for example). This circuit is an example of black level clamp circuit in video signal processing.

There is also known a circuit using a digital integrating circuit in place of the analog integrating circuit described above (see Patent Document 2, for example). In an offset adjusting circuit using a digital integrating circuit, the difference between an AD-converted amplifier output and a predetermined reference value is digital-integrated and the integrated result is converted to an analog signal by a DA converter, to generate a desired clamp voltage.

### Patent Document 1: Japanese Laid-Open Patent Publication No. 5-153428

### Patent Document 2: Japanese Laid-Open Patent Publication No. 2000-224440

### DISCLOSURE OF THE INVENTION

### Problems to be Solved by the Invention

To configure the offset adjusting circuit using an analog integrating circuit as a semiconductor circuit, it is sometimes necessary to place resistance elements and capacitance elements for constituting the analog integrating circuit outside the semiconductor circuit, and this cause a problem of increasing the number of components mounted. Also, even if such resistance elements and capacitance elements can be incorporated in the semiconductor circuit, the following problems arise. The time constant of the analog integrating circuit will be fixed, and thus some amount of time will be necessary before the control is stabilized at the time of power-on and the like. Also, the area of the semiconductor circuit will increase by the elements incorporated.

Contrarily, in the offset adjusting circuit using a digital integrating circuit, the area can be small compared with other offset adjusting circuits owing to the digitized integrating circuit, and also optimization control of the time constant is permitted. The circuit stability therefore increases compared with one using an analog integrating circuit.

However, the offset adjusting circuit using a digital integrating circuit is required to convert the digital integrated result to an analog signal with a DA converter to generate a clamp voltage. In view of this, when the AD converter is further enhanced in resolution in future, the DA converter also needs to be enhanced in resolution like the AD converter. This causes a problem that the circuit configuration will be complicated and large in scale.

In recent years, equipment such as videos and cameras adopting the offset adjusting circuits described above has been made further smaller in size, lighter in weight and lower in power consumption. In cameras, in particular, which have found widespread use as cellular phones' embedded cameras, compact digital cameras and the like, requests for further smaller sizes and lower power are unavoidable. Moreover, requests for further higher performance have been made year after year: For cellular phones' embedded cameras, performance as high as that of compact digital cameras has been requested.

In embedding a camera module in such small equipment, external components will block attainment of a smaller size. Also, when the circuit scale increases resulting in increase in power consumption, the battery will not last long. Hence, the conventional offset adjusting circuits described above fail to satisfy the above requests.

In view of the above problems, an object of the present invention is providing an offset adjusting circuit capable of improving the offset correction accuracy and the stability without increasing the circuit scale.

### Means for Solving the Problems

To solve the problems described above, the offset adjusting circuit of the present invention includes:

an amplifier permitting correction of an offset amount of its output according to an inputted offset correction voltage;

an AD converter for converting the output of the amplifier to a digital value;

an AD output average computation circuit for sampling the output value of the AD converter a predetermined number of times to compute an average value and outputting the result as an AD output average value;

a subtraction circuit for subtracting the AD output average value from a predetermined output reference value and outputting the result;

a clip circuit for generating first correction information indicating an offset correction amount for the amplifier and second correction information indicating an offset correction amount for the output of the AD converter;

a digital integrating circuit for outputting an offset correction value obtained by digital-integrating the first correction information;

a DA converter for converting the offset correction value to an analog signal and outputting the result:

an offset voltage generation circuit for converting the analog signal outputted from the DA converter to a predetermined voltage and outputting the voltage to the amplifier as the offset correction voltage; and

an addition circuit for adding the second correction information to the output value of the AD converter and outputting the result.

With the above configuration, the offset correction for the output of the amplifier (analog offset correction) and the offset correction for the output of the AD converter (digital offset correction) can be selectively used. Hence, even if the AD converter is enhanced in resolution, the resolution of the DA converter used for the DA conversion of the digital integrated result can be lower than that of the AD converter. In other words, this configuration is contributable to reduction in circuit scale and power consumption.

The offset adjusting circuit described above may further include an addition circuit for adding a predetermined output correction value to the output of the addition circuit.

Thus, the output reference value of the offset adjusting circuit can be set at an arbitrary value.

In the offset adjusting circuit described above, the clip circuit may generate the first correction information and the second correction information according to the output of the subtraction circuit.

Thus, the analog offset correction and the digital offset correction can be selectively used depending on the difference between the output reference value and the output value of the AD converter.

Alternatively, the offset adjusting circuit of the present invention includes:

an amplifier permitting correction of an offset amount of its output according to an inputted offset correction voltage;

an AD converter for converting the output of the amplifier to a digital value;

a first AD output average computation circuit for sampling the output value of the AD converter a predetermined number of times to compute an average value and outputting the result as a first AD output average value;

a first subtraction circuit for subtracting the first AD output average value from a predetermined output reference value and outputting the result;

a clip circuit for generating first correction information indicating an offset correction amount for the amplifier and second correction information indicating whether or not offset correction is necessary for the output of the AD converter;

a first digital integrating circuit for outputting an offset correction value obtained by digital-integrating the first correction information;

a DA converter for converting the offset correction value to an analog signal:

an offset voltage generation circuit for converting the analog signal outputted from the DA converter to a predetermined voltage and outputting the voltage to the amplifier as the offset correction voltage;

an addition circuit for receiving the output value of the AD converter as one addition input value;

a second AD output average computation circuit for sampling the output value of the addition circuit a predetermined number of times to compute an average value and outputting the result as a second AD output average value;

a second subtraction circuit for subtracting the second AD output average value from the output reference value and outputting the result; and

a second digital integrating circuit for digital-integrating the output of the second subtraction circuit and outputting the result to the addition circuit as the other addition input value according to the second correction information.

With the above configuration, since the difference between the output reference value and the output value of the AD converter is integrated, the digital offset correction can be made more stably.

In the offset adjusting circuit described above, the offset voltage generation circuit may generate the offset correction voltage according to a reference voltage of the AD converter or a voltage from a reference voltage source.

With the above configuration, since the offset voltage generation circuit generates the offset correction voltage based on the reference voltage of the AD converter (or a voltage from a reference voltage source circuit), the relative variation between the output voltage of the offset voltage generation circuit and the reference voltage of the AD converter is reduced, and therefore the correction accuracy and stability of the offset adjusting circuit improves.

In the offset adjusting circuit described above, the AD output average computation circuit may include:

a data hold circuit for holding an average value to be outputted;

an AD output clip circuit for clipping an input data to a value within a predetermined range;

a first averaging circuit for computing an average value of data inputted from the AD output clip circuit a predetermined number of times successively; and

a second averaging circuit for computing an average value between the average value held in the data hold circuit and the average value computed by the first averaging circuit, and outputting the result as well as permitting the result to be held in the data hold circuit.

In the offset adjusting circuit described above, the first AD output average computation circuit and the second AD output average value computation circuit may respectively include:

a data hold circuit for holding an average value to be outputted;

an AD output clip circuit for clipping an input data to a value within a predetermined range;

a first averaging circuit for computing an average value of data inputted from the AD output clip circuit a predetermined number of times successively; and

a second averaging circuit for computing an average value between the average value held in the data hold circuit and the average value computed by the first averaging circuit, and outputting the result as well as permitting the result to be held in the data hold circuit.

With the above configurations, the AD output average value is computed in correlation with the previous AD output average value. Thus, if noise is suddenly included in the input of the amplifier, for example, the influence of such noise can be reduced.

### EFFECT OF THE INVENTION

According to the present invention, the offset correction accuracy and the stability can be improved without increasing the circuit scale.

### BRIEF DESCRIPTION OF THE DRAWINGS

FIG. 1 is a block diagram of an offset adjusting circuit of Embodiment 1.

FIG. 2 is a view showing a configuration of a pixel area of an image sensor.

FIG. 3 is a view showing drive timing of the offset adjusting circuit.

FIG. 4 is a view showing the relationship of the offset correction amount of AD output with the DA set value.

FIG. 5 is a block diagram of an AD output average computation circuit 103.

FIG. 6 shows views of the input/output characteristic of a clip circuit.

FIG. 7 is a partial enlarged view of FIG. 4.

FIG. 8 is a view showing level changes of a signal observed when analog offset correction and digital offset correction are performed.

FIG. 9 is a block diagram of an offset adjusting circuit of Embodiment 2.

### DESCRIPTION OF REFERENCE NUMERALS

100 Offset adjusting circuit
101 Amplifier
102 AD converter
103 AD output average computation circuit
103a NOR circuit
103b Clip circuit
103c Pixel averaging circuit
103d Averaging circuit
103e Data hold circuit
104 AD output target value register
105 Subtractor
106 Clip circuit
107 Divider
108 Data hold circuit
109 Subtractor
110 Reference voltage monitor
111 DA converter
112 Offset voltage generation circuit
113 Digital offset correction circuit
113a Correction value register
113b Adder
114 Digital clamp circuit
114a Output reference code set value register
114b Adder
200 Offset adjusting circuit
201 Clip circuit
202 Digital offset correction circuit
202a Adder
202b AD output average computation circuit
202c Subtractor
202d Divider
202e Data hold circuit
202f Adder

### BEST MODE FOR CARRYING OUT THE INVENTION

Hereinafter, embodiments of the present invention will be described with reference to the relevant drawings.

### Embodiment 1

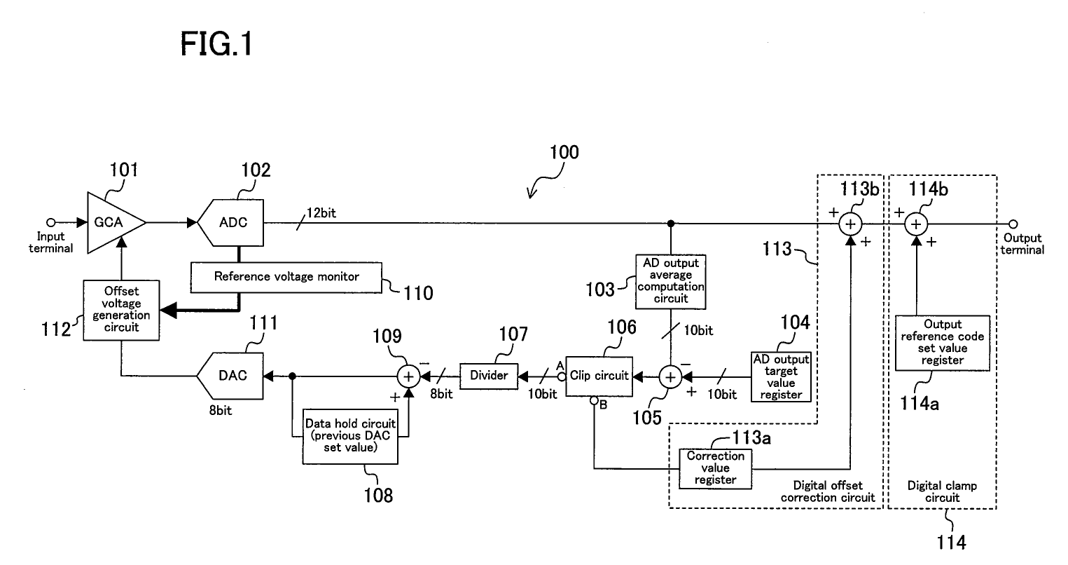

FIG. 1 is a block diagram of an offset adjusting circuit 100 of Embodiment 1 of the present invention. The offset adjusting circuit 100 is used as part of an analog front-end circuit for processing a signal from an image sensor in a digital camera and the like.

One of factors essential in processing of a signal from an image sensor is clamping the output so that the black level reference is fixed at any time. The offset adjusting circuit 100 is used for the purpose of clamping the AD-converted output value of a black level signal outputted from an image sensor to a fixed value.

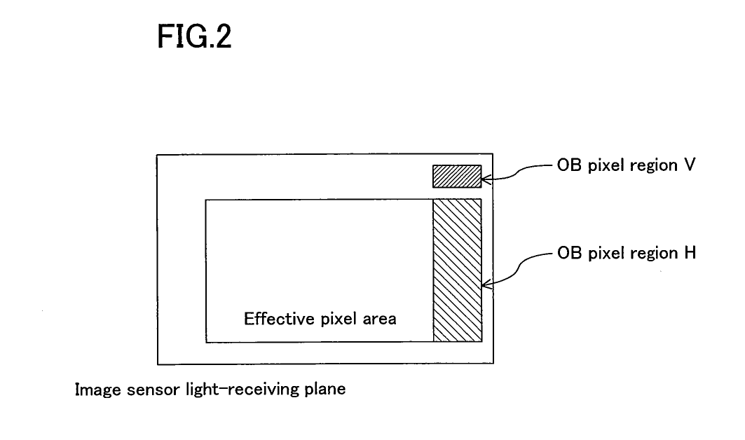

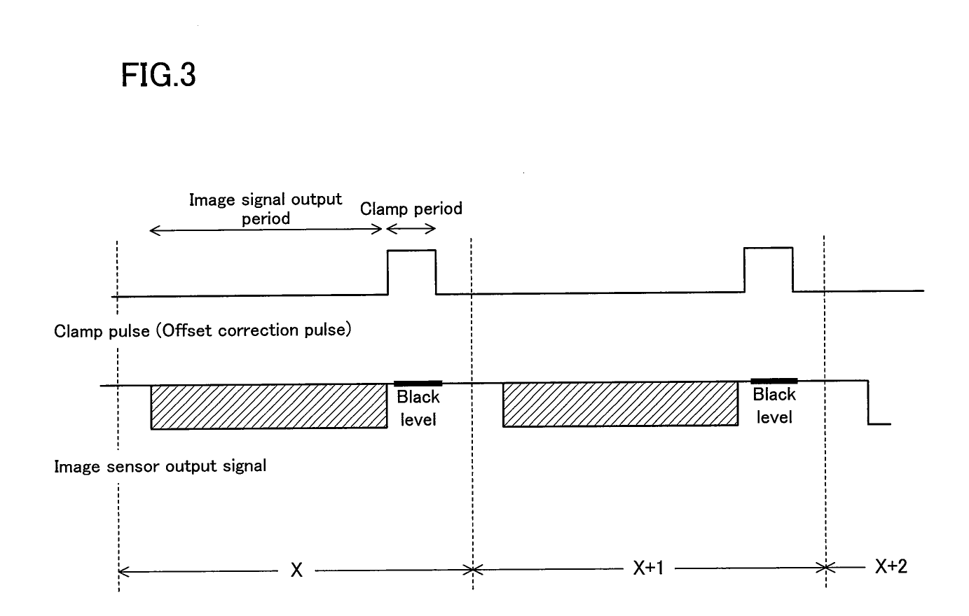

The black level signal as used herein refers to an output signal from a pixel in a so-called OB pixel region in an image sensor (see FIG. 2). It is during the period of output of a high (H) level clamp pulse as shown in FIG. 3 that the offset adjusting circuit 100 performs offset correction operation. The offset adjusting circuit 100 corrects an output offset so that the output of an AD converter corresponding to a signal outputted from the OB pixel region during the H-level clamp pulse period is fixed to a predetermined output reference value (hereinafter called the first AD output reference value).

(Configuration of Offset Adjusting Circuit 100)

As shown in FIG. 1, the offset adjusting circuit 100 includes an amplifier 101 (abbreviated as GCA in the figure), an AD converter 102 (abbreviated as ADC in the figure), an AD output average computation circuit 103, an AD output target value register 104, a subtractor 105, a clip circuit 106, a divider 107, a data hold circuit 108, a subtractor 109, a reference voltage monitor 110, a DA converter 111 (abbreviated as DAC in the figure), an offset voltage generation circuit 112, a digital offset correction circuit 113 and a digital clamp circuit 114.

The amplifier 101, which is a variable gain amplifier for amplifying a signal inputted via an input terminal, adjusts an offset of its output according to an offset correction voltage (to be described later) received from the offset voltage generation circuit 112.

The AD converter 102 AD-converts the output of the amplifier 101 and outputs the resultant signal. In this embodiment, the resolution of the AD converter 102 is 12 bits.

The AD output average computation circuit 103 clips each of the outputs of 16 pixels (12-bit output for each pixel) from the AD converter 102 to a value within a predetermined range, and outputs an average value of the clipped outputs of 16 pixels (hereinafter called an AD output average value).

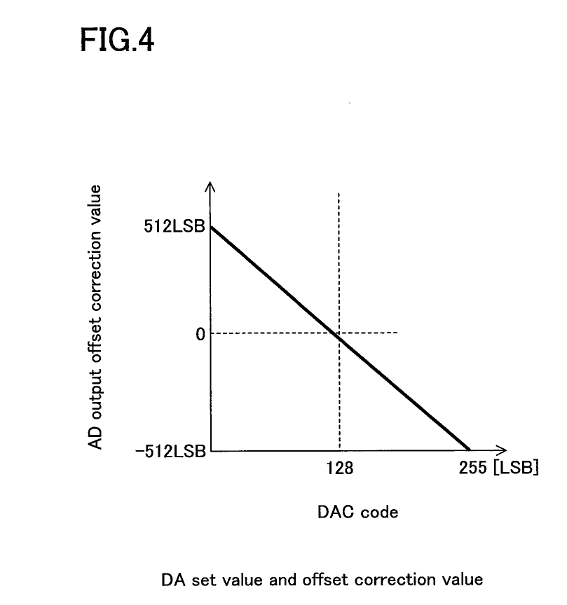

Assuming that the offset adjustment range for the output of the AD converter 102 is ±512 LSBs as shown in FIG. 4, any occurrence of an AD output average value exceeding this range will be considered out of the offset adjustment. Hence, the AD output average computation circuit 103 does not have to perform computation using all of the 12-bit output of the AD converter 102, but may cut out some least significant bits for the computation. In this embodiment, specifically, data of 10 least significant bits of the 12-bit output of the AD converter 102 is used for the average computation by the AD output average computation circuit 103.

As described above, the bit width used for the average computation depends on the adjustment range of the offset adjusting circuit. For example, to permit offset adjustment within ±1023 LSBs, the bit width used for the average computation must be increased.

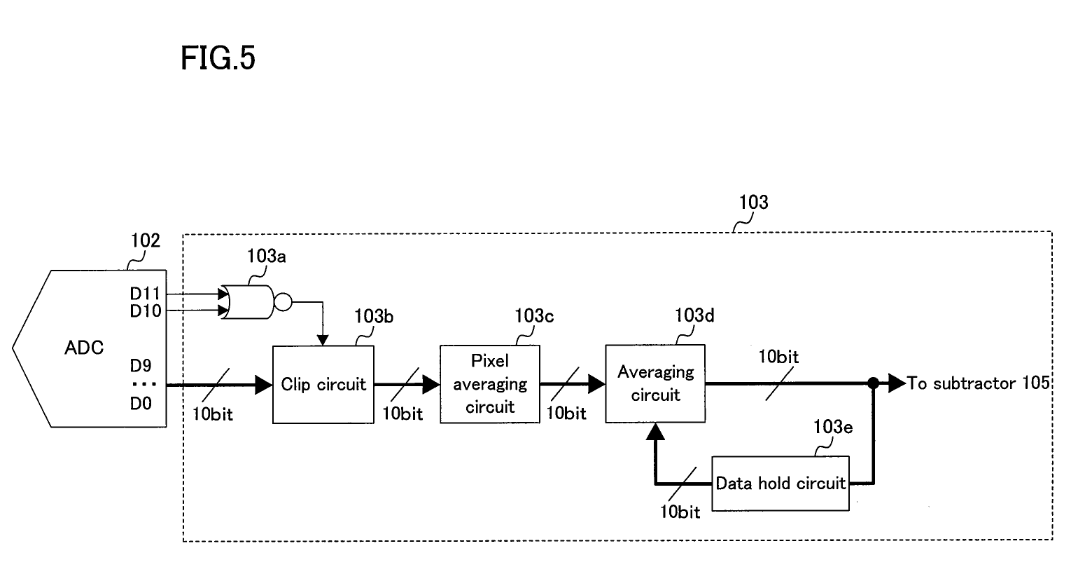

As shown in FIG. 5, the AD output average computation circuit 103 includes a NOR circuit 103a, a clip circuit 103b, a pixel averaging circuit 103c, an averaging circuit 103d and a data hold circuit 103e.

The NOR circuit 103a receives the two most significant bits from the AD converter 102, and the output thereof is connected to the clip circuit 103b. The NOR circuit 103a therefore outputs a low (L) level signal to the clip circuit 103b if the value outputted from the AD converter 102 exceeds 1023.

The clip circuit 103b clips data to be inputted into the pixel averaging circuit 103c to a value of 1023 or less. To state in more detail, the clip circuit 103b receives the 10 least significant bits from the AD converter 102, and outputs 1023 to the pixel averaging circuit 103c if the output of the AD converter 102 exceeds 1023 (specifically, if the output of the NOR circuit 103a is in L level), or outputs the data of the 10 least significant bits of the AD converter 102 to the pixel averaging circuit 103c if the output of the AD converter 102 is 1023 or less.

The pixel averaging circuit 103c computes an average value of the outputs of 16 pixels from the pixel averaging circuit 103c.

The averaging circuit 103d computes an average value between the value held in the data hold circuit 103e and the output of the pixel averaging circuit 103c. For example, if the initial value of the averaging circuit 103d is 0 and the current output of the pixel averaging circuit 103c is 100, the output value of the averaging circuit 103d, that is, the output value of the AD output average computation circuit 103 will be 50. If the next output of the pixel averaging circuit 103c is 150, the output value of the AD output average computation circuit 103 will be 100.

The data hold circuit 103e holds the output of the averaging circuit 103d (or a predetermined initial value when no output is yet received from the averaging circuit 103d such as at the start of operation), and feeds the held value back to the averaging circuit 103d.

Note that the clip circuit 103b, the pixel averaging circuit 103c, the averaging circuit 103d and the data hold circuit 103e respectively output 10-bit data.

The AD output target value register 104 holds the first AD output reference value, which is a fixed value in this embodiment.

The subtractor 105 subtracts the first AD output reference value (held in the AD output target value register 104) from the output of the AD output average computation circuit 103, and outputs the result to the clip circuit 106.

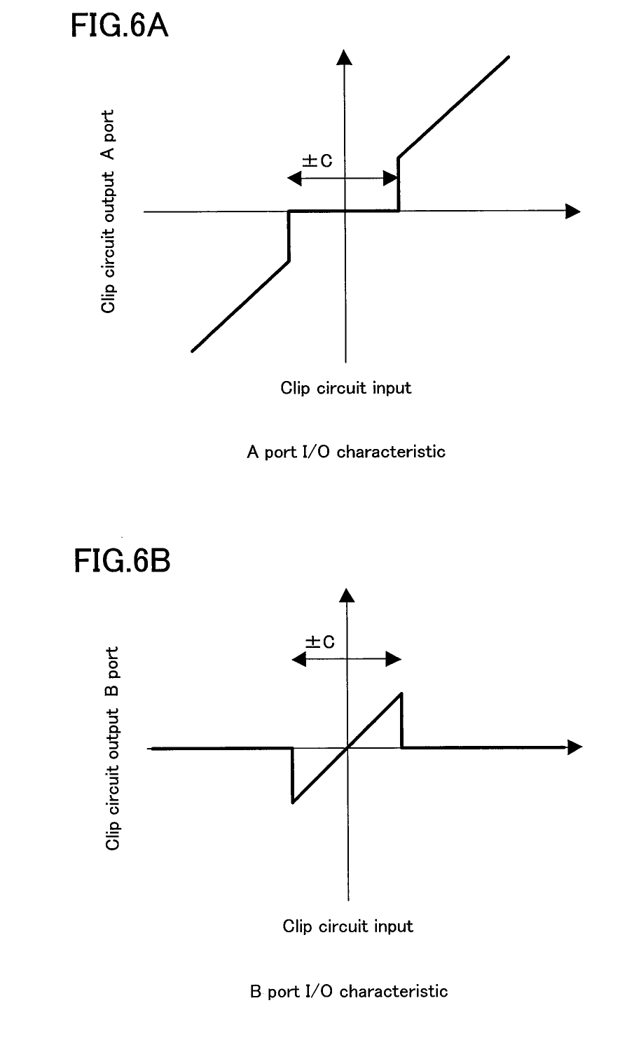

The clip circuit 106 outputs values obtained by clipping the output of the subtractor 105 to a predetermined value to the divider 107 via A port and to the digital offset correction circuit 113 via B port. Specifically, the output characteristic of the clip circuit 106 is set as shown in FIG. 6, for example, in which C represents the clip set value. As shown in FIG. 6, if the output of the subtractor 105 falls outside the range of ±C (output of subtractor 105<−C or +C<output of subtractor 105), the clip circuit 106 outputs the data from the subtractor 105 via the A port and outputs 0 via the B port. If the output of the subtractor 105 falls within the range of ±C (−C≦output of subtractor 105≦+C), the clip circuit 106 outputs 0 via the A port and outputs the data from the subtractor 105 via the B port. In this way, a dead band can be provided in the range of the correction using the DA converter 111.

The value of C can be set at an arbitrary value by providing a register in the subtractor 105, for example. The operation stability of the offset adjusting circuit is determined with this set value.

Note that the AD output target value register 104, the subtractor 105 and the clip circuit 106 respectively output 10-bit data.

The divider 107 converts the output (10 bits) of the clip circuit 106 to 8 bits and outputs the result. Specifically, the divider 107 shifts the 8 most significant bits of the 10-bit output toward lower-order positions by two bits. The shift amount in the divider 107 must be determined depending on the relationship between the set value for the DA converter 111 and the output value of the AD converter 102. For example, if the relationship between the set value for the DA converter 111 and the output value of the AD converter 102 is 1:4, the output value of the clip circuit 106 must be divided by a value of 4 or more.

The data hold circuit 108 holds the set value for the DA converter 111 (i.e., the output value of the subtractor 109).

The subtractor 109 subtracts the current output value of the divider 107 from the value held in the data hold circuit 108 (i.e., the previous set value for the DA converter 111), and outputs the subtracted result (hereinafter, called the offset correction value) to the DA converter 111. Note that the subtractor 109 outputs 0 if the value held in the data hold circuit 108 is smaller than the value outputted from the divider 107. The subtractor 109 and the data hold circuit 108 constitute a digital integrating circuit.

The reference voltage monitor 110 outputs information indicating the reference voltage of the AD converter 102 (or the output voltage of a reference voltage source circuit) to the offset voltage generation circuit 112.

The DA converter 111 receives the offset correction value outputted from the subtractor 109 as the set value (DA set value), and outputs a voltage corresponding to the DA set value to the offset voltage generation circuit 112 during the L-level clamp pulse period (see FIG. 2). In this embodiment, the resolution of the DA converter is 8 bits.

The offset voltage generation circuit 112 outputs an offset correction voltage corresponding to the voltage outputted from the DA converter 111 to the amplifier 101, to thereby perform offset adjustment of the output of the amplifier 101 (called analog offset correction). The offset correction voltage at time X is specifically a voltage Vobref(X) expressed by equation (1) or (2) below.

$$\begin{matrix}[ Equation 1 ] & \\ Vobref ( X ) = Vadref + ( D ( X - 1 ) - 128 ) \frac{Vadref}{256} & ( 1 ) \\ [ Equation 2 ] & \\ Vobref ( X ) = Vadref + Vref + ( D ( X - 1 ) - 128 ) \frac{Vadref}{256} & ( 2 )\end{matrix}$$

In equations (1) and (2) above, the parameters respectively denote the followings.

Vadref: width VREFH-VREFL of the reference voltage of the AD converter

D(X−1): previous set value for the DA converter 111

ΔVref: minute voltage error between the AD reference voltage and the offset voltage generation circuit

The time X indicates the X-th clamping (i.e., not the X-th pixel sampling)

Note that in this embodiment, the period of the H-level clamp pulse corresponds to the signal period of 16 pixels.

With the offset correction voltage described above, the output value D_{AD}(t) of the AD converter 102 subjected to the offset adjustment is expressed as follows.

$$\begin{matrix}[ Equation 3 ] & \\ {D}_{AD} ( t ) = ( A \cdot Vin ( t ) - Vobref ( X ) + Vadref ) \cdot \frac{4095}{Vadref} [ LSB ] & ( 3 )\end{matrix}$$

In equation (3) above, the parameters respectively denote the followings.

t: time required to read one pixel; i.e., 16 t is necessary to read 16 pixels

Vin(t): amplitude of input signal to the amplifier 101 at time t

A: gain value of the amplifier 101

From equation (3) it is found that the output offset can be adjusted by varying the Vobref(X) value with respect to Vadref. In this embodiment, the offset adjustment is performed so that the black level reference agrees with the first AD output reference using OB region pixels H (see FIG. 2) for each line of an image sensor.

Note that in the case that the output of the subtractor 105 falls within the range of ±C (−C≦output of subtractor 105≦±C), in which the clip circuit 106 outputs 0 via the A port as described above, no analog offset correction will virtually be performed.

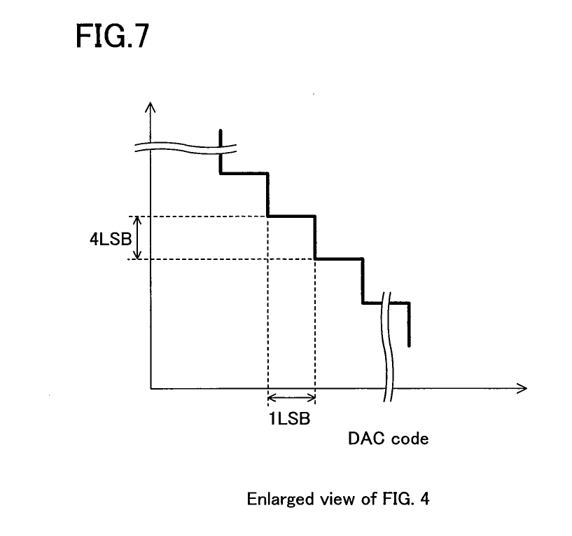

Also, in this embodiment, in the light of the relationship in resolution between the AD converter 102 and the DA converter 111, every 1-LSB output change of the DA converter 111 can change the output value of the AD converter 102 by 4 LSBs. In other words, since the DA converter 111 is low in resolution compared with the AD converter 102, the output value of the AD converter 102 changes by 4 LSBs every 1-LSB change of the set value for the DA converter 111 (i.e., the set value for the DA converter 111 and the output value of the AD converter 102 are in the relationship of 1:4), and thus the analog offset correction is discontinuous as shown in FIG. 7.

Offset adjustment with an accuracy lower than the above is left to digital offset correction (described later) performed by the digital offset correction circuit 113 to follow. Note that the lower limit of the clip value is ±4 LSBs considering the relationship between the AD converter 102 and the DA converter 111.

The digital offset correction circuit 113 performs offset adjustment for the output of the AD converter 102 (called digital offset correction) by adding a predetermined value to the output of the AD converter 102. In the case that the output of the subtractor 105 falls outside the range of +C (output of subtractor 105<−C or +C<output of subtractor 105), in which the clip circuit 106 outputs 0 via the B port as described above, no digital offset correction will virtually be performed. The value of C may be set at an arbitrary value greater than the clip lower limit as long as the circuit stability and the correction accuracy are not impaired.

The digital offset correction circuit 113 specifically includes a correction value register 113a and an adder 13b.

The correction value register 113a holds the output from the B port of the clip circuit 106.

The adder 113b adds the value held in the correction value register 113a to the output of the AD converter 102 and outputs the result.

The digital clamp circuit 114 sets the black level reference at an arbitrary value. Specifically, the digital clamp circuit 114 includes an output reference code set value register 114a and an adder 114b.

The output reference code set value register 114a holds a predetermined value for setting the black level reference at an arbitrary value.

The adder 114b adds the value held in the output reference code set value register 114a to the output of the adder 113b and outputs the result.

(Operation of Offset Adjusting Circuit 100)

First, only an image signal component is extracted from the output of the OB region pixels H in an image sensor (not shown) by a correlated double sampling (CDS) circuit (not shown). The extracted image signal component (analog signal) is inputted into the offset adjusting circuit 100 via the input terminal (this input may be differential or single).

The amplifier 101 amplifies the analog signal inputted from the CDS circuit via the input terminal and outputs the amplified signal to the AD converter 102. At this time, the offset voltage generation circuit 112 has generated the offset correction voltage (or a predetermined initial voltage) obtained at the previous offset adjustment and applied the voltage to the amplifier 101. The AD converter 102 converts the analog signal outputted from the amplifier 101 to a 12-bit digital value and outputs the digital value to the AD output average computation circuit 103 and the digital offset correction circuit 113.

In the AD output average computation circuit 103, first, the clip circuit 103b clips the input 12-bit digital value to 10 bits. Thereafter, the pixel averaging circuit 103c averages the 16-pixel outputs of the clip circuit 103b, and outputs the resultant AD output average value to the averaging circuit 103d. The averaging circuit 103d averages the value held in the data hold circuit 103e (the previous output of the averaging circuit 103d or a predetermined initial value) and the output of the pixel averaging circuit 103c, and outputs the resultant value to the subtractor 105. In this way, by referring to the previous AD output average value, the AD output average values computed during the respective clamp periods can be correlated with each other. Therefore, a sudden occurrence of noise in the output of the image sensor, if any, can be made less influential.

The subtractor 105 subtracts the first AD output reference value (held in the AD output target value register 104) from the output of the AD output average value computation circuit 103, and outputs the result to the clip circuit 106. The clip circuit 106 clips the output of the subtractor 105 to a predetermined value based on the output characteristic shown in FIG. 6, and outputs the results to the divider 107 via the A port and to the correction value register 113a via the B port. The outputs from the A port and the B port are both 10-bit data.

The divider 107 converts the input 10-bit data to 8 bits and outputs the result to the subtractor 109. The subtractor 109 subtracts the output of the divider 107 from the value held in the data hold circuit 108 (i.e., the previous set value for the DA converter 111). The subtracted result is outputted to the DA converter 111 as the current offset correction value.

The DA converter 111 outputs a voltage corresponding to the offset correction value to the offset voltage generation circuit 112 during the L-level clamp pulse period (see FIG. 2), whereby the offset of the amplifier 101 is adjusted according to equation (1) described above. In this way, the offset correction value computed during the X-th H-level clamp pulse period is reflected during the (X+1)th clamp period, in which analog offset correction for the (X+1)th output of the AD converter 102 (AD output) is performed.

Meanwhile, as for the AD output (12 bits) inputted into the digital offset correction circuit 113, the adder 113b adds the value held in the correction value register 113a to the AD output to perform digital offset correction, and outputs the result to the digital clamp circuit 114. In this way, the black level signal from the image sensor can be clamped to the first AD output reference value by the digital offset correction circuit 113.

In digital signal processing performed for the AD-converted image signal at a stage downstream of the offset adjusting circuit 100, the black level reference may be set at an arbitrary value prior to the execution of the digital signal processing. On such an occasion, the first AD output reference may be changed to various values for offset adjustment of the amplifier 101, for example. In this case, however, the output dynamic range of the amplifier 101 will always vary with respect to the dynamic range of the AD converter 102. In particular, as the first AD output reference value is greater, the output dynamic range of the amplifier 101 will be narrower, and thus the S/N characteristic of the circuit may possibly be adversely affected. For this reason, the value of the analog offset correction by the DA converter 111 is desirably fixed at any time.

In view of the above, on the above occasion, the first AD output reference value is not changed, but an arbitrary set value (called the second AD output reference value) is set in advance in the output reference code set value register 114a.

For example, assuming that the first AD output reference value is set at 128 LSBs and the black level reference desired to be outputted from the output terminal of the offset adjusting circuit 100 is 256 LSB, +128 LSB is set at the output reference code set value register 114a.

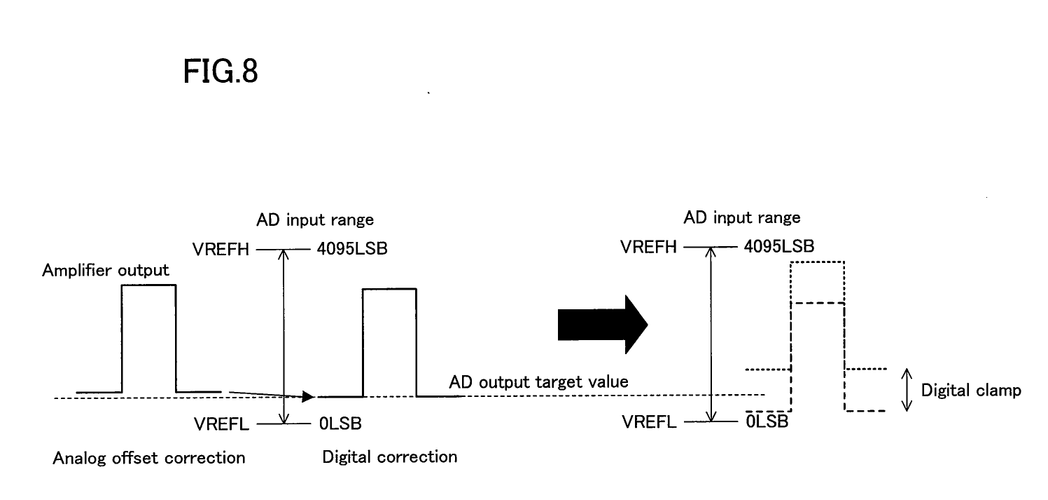

By the above setting, in the digital clamp circuit 114, the second AD output reference value is added to the output of the digital offset correction circuit 113 by the adder 114b, to output 256 as the black level reference outputted from the output terminal (see FIG. 8). Also, if it is desired to output a value lower than the first AD output reference value as the black level reference, a negative value may be set at the output reference code set value register 114a as the second AD output reference value. Hence, the value of the analog offset correction by the DA converter 111 is fixed to permit stabilization of the analog characteristics of the amplifier 101.

As described above, in this embodiment, in which no analog integrating circuit is used, the stability of the offset adjustment improves, and also external components such as resistance elements can be reduced.

Also, the analog offset correction and the digital offset correction are selectively used depending on the offset amount. Hence, even if the AD converter for AD conversion of the output of the amplifier is enhanced in resolution, the resolution of the DA converter used for DA conversion of the digital integration result can be lower than that of the AD converter. That is, this configuration is contributable to reduction in circuit scale and power consumption.

The offset voltage generation circuit 112 generates the offset correction voltage based on the reference voltage of the AD converter 102 (or a voltage from a reference voltage source circuit). It is therefore possible to reduce the influence on the output value of a variation of the voltage value that may occur due to the dependence characteristic on the reference voltage of the AD output and the power supply voltage and the temperature dependence characteristic. In other words, the relative variation between the output voltage of the offset voltage generation circuit 112 and the reference voltage of the AD converter 102 is reduced, whereby the correction accuracy and stability of the offset adjusting circuit further improve.

### Embodiment 2

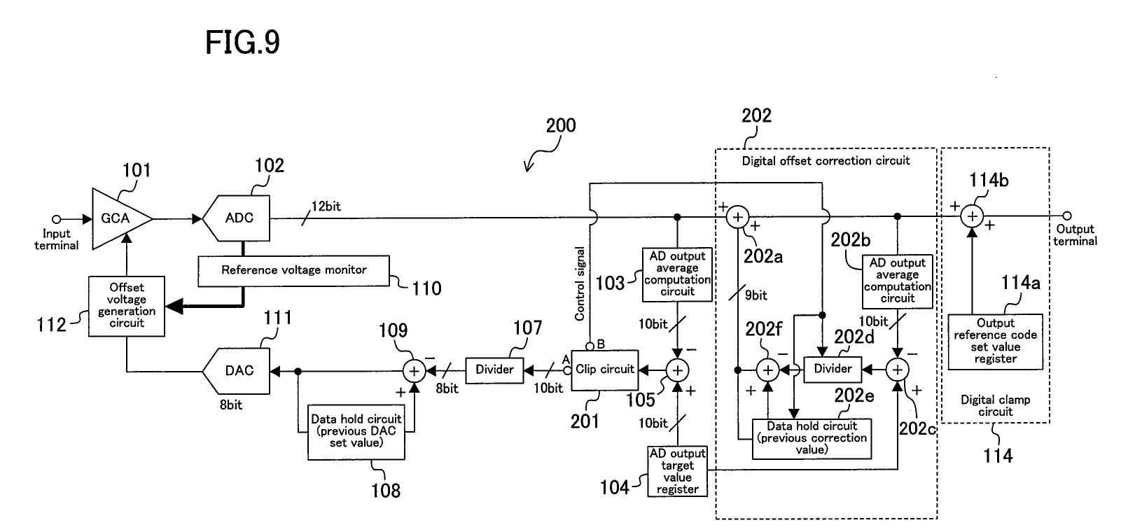

FIG. 9 is a block diagram of an offset adjusting circuit 200 of Embodiment 2 of the present invention. As shown in FIG. 9, the offset adjusting circuit 200 is different from the offset adjusting circuit 100 in that a clip circuit 201 is provided in place of the clip circuit 106 and a digital offset correction circuit 202 is provided in place of the digital offset correction circuit 113. In the following description, components having substantially the same functions as those in Embodiment 1 are denoted by the same reference numerals, and description thereof is not repeated.

If the output of the subtractor 105 falls outside the range of +C (i.e., output of subtractor 105<−C or +C<output of subtractor 105), the clip circuit 201 outputs the data from the subtractor 105 via the A port (see FIG. 6) and outputs a H-level control signal to the digital offset correction circuit 202 via the B port. If the output of the subtractor 105 falls within the range of ±C (±C≦output of subtractor 105≦+C), the clip circuit 201 outputs 0 via the A port and outputs a L-level control signal to the digital offset correction circuit 202 via the B port.

To ensure stable operation of the offset adjusting circuit, the operations of the analog offset correction and the digital offset correction must be separated from each other without fail. If the analog offset correction and the digital offset correction are performed simultaneously, the circuit may become unstable and at worst may fail to be converged. Caution must be taken to avoid this occurrence. In this embodiment, a dead band is also provided for each of the analog offset correction range and the digital offset correction range in the clip circuit 201, to thereby attain a configuration that only the offset value in either one of the ranges is updated at any time.

The digital offset correction circuit 202 includes an adder 202a, an AD output average computation circuit 202b, a subtractor 202c, a data hold circuit 202e and an adder 202f.

The adder 202a adds the output of the adder 202f to the output of the AD converter 102 and outputs the result.

The AD output average computation circuit 202b, having substantially the same circuit configuration as the AD output average computation circuit 103, clips each of the outputs (12-bit outputs) of 16 pixels outputted from the adder 202a to a value within a predetermined range, and outputs an average value (10 bits) of the clipped outputs of 16 pixels.

The subtractor 202c subtracts the output value of the AD output average computation circuit 202b from the first AD output reference value held in the AD output target value register 104.

The divider 202d converts the output (10 bits) of the subtractor 202c to 9 bits (bit conversion) and outputs the result. Specifically, the divider 202d shifts the 9 most significant bits of the 10-bit output toward lower-order positions by one bit. The 1-bit shift of a value is equivalent to dividing the value by 2. If the output of the subtractor 202c changes by 2 LSBs or more with this operation, the digital offset correction is to be executed by the digital offset correction circuit 202. Note that the bit conversion is not necessarily required depending on the circumstances of use of the offset adjusting circuit. Note also that the divider 202d receives the control signal outputted from the clip circuit 201 and, if the inputted signal is in H level, resets the output value to 0.

The data hold circuit 202e holds the output of the adder 202f. The data hold circuit 202e also receives the control signal outputted from the clip circuit 201 and, if the control signal is in H level, resets the output value to 0.

The adder 202f adds the output of the data hold circuit 202e (i.e., the previous output of the adder 202f) to the output of the divider 202d, and outputs the result to the adder 202a as the correction value. The adder 202f and the data hold circuit 202e constitute a digital integrating circuit.

In the offset adjusting circuit 200 described above, if the output of the subtractor 105 falls outside the range of ±C, the analog offset correction is performed as in the offset adjusting circuit 100. At this time, the H-level control signal is inputted into the digital offset correction circuit 202 via the B port of the clip circuit 201, resetting the outputs of the divider 202d and the data hold circuit 202e to 0. The output of the adder 202f then becomes 0, and thus no digital offset correction is performed.

Contrarily, if the output of the subtractor 105 falls within the range of +C, in which the clip circuit 201 outputs 0 from the A port, the analog offset correction value is not updated but fixed to the previous correction value. At this time, the digital offset correction circuit 202 performs digital offset correction in the following manner.

First, the AD output average computation circuit 200b computes the AD output average value from the data of 16 pixels outputted from the adder 202a and outputs the result to the subtractor 202c. The subtractor 202c subtracts the AD output average value outputted from the AD output average computation circuit 202b from the first AD output reference value. The output of the subtractor 202c is inputted into the divider 202d, to be subjected to bit shift from 10 bits to 9 bits. The adder 202f then adds the output of the divider 202d to the value held in the data hold circuit 202e (i.e., the previous correction value) and outputs the result to the adder 202a. The adder 202a adds the output value of the adder 202f to the AD output value of the AD converter 102, and outputs the result to the digital clamp circuit 114 and the AD output average computation circuit 202b.

As described above, in the digital offset correction circuit 202, the AD output average values computed during the respective clamp periods can be correlated with each other by means of the data hold circuit 202e and the adder 202f. Thus, the digital offset correction can be performed more stably.

In the above embodiments, the offset adjustment is performed using the OB region pixels H for each line of an image sensor. Alternatively, offset adjustment may be made using OB region pixels V once for each screen. Otherwise, both OB region pixels may be used for the offset adjustment. Also, in the above embodiments, 16 OB region pixels were used for computation of the average value. The number of pixels used for the average value computation is not limited to this.

### INDUSTRIAL APPLICABILITY

The offset adjusting circuit according to the present invention has the effect that the offset correction accuracy and the stability can be improved without increasing the circuit scale, and thus is useful as an offset adjusting circuit for performing offset correction for the amplifier output and the like.

1. An offset adjusting circuit comprising:
an amplifier permitting correction of an offset amount of its output according to an inputted offset correction voltage;
an AD converter for converting the output of the amplifier to a digital value;
an AD output average computation circuit for sampling the output value of the AD converter a predetermined number of times to compute an average value and outputting the result as an AD output average value;
a subtraction circuit for subtracting the AD output average value from a predetermined output reference value and outputting the result;
a clip circuit for generating first correction information indicating an offset correction amount for the amplifier and second correction information indicating an offset correction amount for the output of the AD converter;
a digital integrating circuit for outputting an offset correction value obtained by digital-integrating the first correction information;
a DA converter for converting the offset correction value to an analog signal and outputting the result:
an offset voltage generation circuit for converting the analog signal outputted from the DA converter to a predetermined voltage and outputting the voltage to the amplifier as the offset correction voltage; and
an addition circuit for adding the second correction information to the output value of the AD converter and outputting the result.

2. The offset adjusting circuit of claim 1, further comprising an addition circuit for adding a predetermined output correction value to the output of the addition circuit.

3. The offset adjusting circuit of claim 1, wherein the clip circuit generates the first correction information and the second correction information according to the output of the subtraction circuit.

4. An offset adjusting circuit comprising:
an amplifier permitting correction of an offset amount of its output according to an inputted offset correction voltage;
an AD converter for converting the output of the amplifier to a digital value;
a first AD output average computation circuit for sampling the output value of the AD converter a predetermined number of times to compute an average value and outputting the result as a first AD output average value;
a first subtraction circuit for subtracting the first AD output average value from a predetermined output reference value and outputting the result;
a clip circuit for generating first correction information indicating an offset correction amount for the amplifier and second correction information indicating whether or not offset correction is necessary for the output of the AD converter;
a first digital integrating circuit for outputting an offset correction value obtained by digital-integrating the first correction information;
a DA converter for converting the offset correction value to an analog signal:
an offset voltage generation circuit for converting the analog signal outputted from the DA converter to a predetermined voltage and outputting the voltage to the amplifier as the offset correction voltage;
an addition circuit for receiving the output value of the AD converter as one addition input value;
a second AD output average computation circuit for sampling the output value of the addition circuit a predetermined number of times to compute an average value and outputting the result as a second AD output average value;
a second subtraction circuit for subtracting the second AD output average value from the output reference value and outputting the result; and
a second digital integrating circuit for digital-integrating the output of the second subtraction circuit and outputting the result to the addition circuit as the other addition input value according to the second correction information.

5. The offset adjusting circuit of claim 1, wherein the offset voltage generation circuit generates the offset correction voltage according to a reference voltage of the AD converter or a voltage from a reference voltage source.

6. The offset adjusting circuit of claim 4, wherein the offset voltage generation circuit generates the offset correction voltage according to a reference voltage of the AD converter or a voltage from a reference voltage source.

7. The offset adjusting circuit of claim 1, wherein the AD output average computation circuit comprises:
a data hold circuit for holding an average value to be outputted;
an AD output clip circuit for clipping an input data to a value within a predetermined range;
a first averaging circuit for computing an average value of data inputted from the AD output clip circuit a predetermined number of times successively; and
a second averaging circuit for computing an average value between the average value held in the data hold circuit and the average value computed by the first averaging circuit, and outputting the result as well as permitting the result to be held in the data hold circuit.

8. The offset adjusting circuit of claim 4, wherein the first AD output average computation circuit and the second AD output average value computation circuit respectively comprise:
a data hold circuit for holding an average value to be outputted;
an AD output clip circuit for clipping an input data to a value within a predetermined range;
a first averaging circuit for computing an average value of data inputted from the AD output clip circuit a predetermined number of times successively; and
a second averaging circuit for computing an average value between the average value held in the data hold circuit and the average value computed by the first averaging circuit, and outputting the result as well as permitting the result to be held in the data hold circuit.
